(19) United States
(12) Patent Application Publication
(10) Pub. No.: US 2015/0356573 A1
(43) Pub. Date: Dec. 10, 2015

(54) DYNAMIC SURVEY SYSTEM

(71) Applicant: Opallios, LLC, Santa Clara, CA (US)

(72) Inventors: Peter Zadrozny, Santa Clara, CA (US); Omcar Paradkar, Santa Clara, CA (US); Prashant Tyagi, Santa Clara, CA (US); Dev Natani, Santa Clara, CA (US)

(21) Appl. No.: 14/730,207

(22) Filed: Jun. 3, 2015

Related U.S. Application Data
(60) Provisional application No. 62/010,394, filed on Jun. 10, 2014.

(51) Int. Cl. G06Q 30/02

(52) U.S. Cl. CPC G06Q 30/0201

(57) ABSTRACT

One feature pertains to survey apparatus that includes a survey storage circuit that stores at least one survey having a plurality of questions, a display device that displays the survey to a survey respondent, a survey input device that receives responses to the plurality of questions from the survey respondent, and a survey delivery processing circuit. The processing circuit retrieves the survey from the survey storage circuit, transmits the survey to the display device for display of the survey to the survey respondent, and receives a plurality of responses to the plurality of questions from the survey respondent via the survey input device. The processing circuit further performs at least one of pre-processing, real-time processing, and/or post-processing of at least one question of the survey and/or at least one response to a question of the survey.

### CLAIM OF PRIORITY

The present application for patent claims priority to U.S. Provisional Patent Application No. 62/010,394 entitled “Dynamic Survey System” filed Jun. 10, 2014, the entire disclosure of which is hereby expressly incorporated by reference herein.

### BACKGROUND

1. Field

Various features generally relate to surveys, and in particular a system is described for generating, executing, and storing surveys and associated responses.

2. Background

Traditional methods and systems for survey generation, execution, and analysis have inherent limitations. For example, such traditional methods and systems may be “survey-centric” in that execution of the surveys and analysis of the responses is performed as a calculation of the responses for all of the respondents or groups of respondents to a specific survey. This limits the ability of a survey designer to obtain additional information that may be pertinent to a specific respondent based on responses provided by that respondent.

In other traditional survey administration systems, responses to survey questions may be stored for later analysis. However, in such systems the responses may be stored by themselves without any context as to what the question was that was asked and/or additional contextual information that was available to the respondent at the time they provided their answer.

Moreover, a respondent taking multiple surveys according to a traditional survey administration system may have to enter and/or answer questions that the respondent has already answered in previous surveys. Doing so may burden the respondent and consume valuable time.

There exists a need for improved methods and systems for survey design, execution, and storage that address at least the issues discussed above with traditional survey systems.

### SUMMARY

One feature provides a non-transitory computer-readable medium comprising instructions stored thereon, which when executed by at least one processor, perform the steps of retrieve a survey having a plurality of questions from a survey storage circuit, transmit the survey to a display device for display of the survey to a survey respondent, receive a plurality of responses to the plurality of questions from the survey respondent via a survey input device, and perform at least one of pre-processing, real-time processing, and/or post-processing of at least one question of the survey and/or at least one response to a question of the survey. According to one aspect, the survey storage circuit is adapted to store a plurality of surveys, and the instructions when executed by the processor, further perform the steps of store and manage a plurality of access rights policies associated with a plurality of users, the access rights policies defining which of the plurality of surveys the plurality of users may access and what type of access each user of the plurality of users are allowed. According to another aspect, a first group of users of the plurality of users is associated with a first access rights policy allowing them to access one or more of the plurality of surveys without fee, and a second group of users of the plurality of users is associated with a second access rights policy allowing them to access one or more of the plurality of surveys for a fee.

According to one aspect, the instructions when executed by the processor, further perform the steps of store the plurality of responses at a response database circuit, and store the plurality of questions for which the plurality of responses were received at the response database circuit; and associate each of the plurality of the questions with each of the plurality of responses in order to provide context to the responses stored. According to another aspect, the instructions when executed by the processor, further perform the step of store a question type, a question category, and a question language associated with each question of the plurality of questions. According to yet another aspect, the instructions when executed by the processor, further perform the step of identify potential survey respondents that match one or more prerequisites to take the survey, the one or more prerequisites including at least one of being a specific gender, being within a specific age range, being a specific demographic profile, and/or having a specific domicile.

According to one aspect, the instructions when executed by the processor, further perform the steps of receive, store, and share experiences associated with the survey written by a community of respondents. According to another aspect, the survey includes one or more sections, the one or more sections each including one or more pages, and the one or more pages each including one or more questions of the plurality of questions, and the instructions when executed by the processor, further perform the step of: transmit to the display device one page of the survey at a time. According to yet another aspect, the instructions when executed by the processor, further perform the step of perform pre-processing of at least one question of the survey and/or at least one response to a question of the survey by determining whether a question of the plurality of questions is marked skippable indicating that the question should not be shown to the survey respondent, and/or determining a value by accessing a server and generating one or more additional questions to be provided to the survey respondent if the value is greater than a predefined threshold.

According to one aspect, the instructions when executed by the processor, further perform the step of perform real-time processing of at least one question of the survey and/or at least one response to a question of the survey by determining an amount of time the survey respondent takes to answer a question of the plurality of questions, and/or determining a location on the display device that the survey respondent is focusing their attention on while being shown a question of the plurality of questions. According to another aspect, the instructions when executed by the processor, further perform the step of perform post-processing of at least one question of the survey and/or at least one response to a question of the survey by marking a question of the plurality of questions as skippable, and/or receiving a first response to a first question of the plurality of questions, determining that the first response satisfies a condition, and providing a follow-up question to the survey respondent only after determining that the first response satisfies the condition. According to yet another aspect, the instructions when executed by the processor, further perform the step of assign a unique respondent identification (ID) number to each survey respondent taking the at least one survey, the same respondent ID number being reused by each survey respondent for all subsequent surveys distributed to the survey respondents.

According to one aspect, the survey displayed to the survey respondent is a first survey having a first question, wherein the instructions when executed by the processor, further perform the steps of receive, via the survey input device, a respondent identification (ID) number from the survey respondent taking the first survey, receive, via the survey input device, a first response to the first question of the first survey from the survey respondent, store the first response to the first question of the first survey at a response database circuit, transmit a second survey having the first question to the display device for display of the second survey to the survey respondent, receive, via the survey input device, the respondent ID number from the survey respondent taking the second survey, receive, via the survey input device, a second response to the first question of the second survey from the survey respondent, determine that the respondent ID number received from the survey respondent taking the second survey matches the respondent ID number received from the survey respondent taking the first survey, generate one or more follow-up questions associated with the first question after determining that a difference between the second response and the first response is greater than a predefined threshold value, and transmit the one or more follow-up questions to the display device for display of the one or more follow-up questions to the survey respondent. According to another aspect, the instructions when executed by the processor, further perform the steps of determine, prior to transmitting the plurality of questions of the survey to the display device, that one or more questions of the plurality of questions of the survey have previously been responded to by the survey respondent and responses to the one or more questions are stored at a response database circuit, and pre-populate the one or more questions with the responses stored at the response database circuit and transmit the pre-populated one or more questions to the display device for display to the survey respondent.

Another feature provides a survey apparatus comprising a survey storage circuit adapted to store at least one survey having a plurality of questions, and a survey delivery processing circuit communicatively coupled to the survey storage circuit, the survey delivery processing circuit adapted to retrieve the survey from the survey storage circuit, transmit the survey to a display device for display of the survey to the survey respondent, receive a plurality of responses to the plurality of questions from the survey respondent via a survey input device, and perform at least one of pre-processing, real-time processing, and/or post-processing of at least one question of the survey and/or at least one response to a question of the survey. According to one aspect, the survey apparatus further comprises a survey design circuit adapted to allow a user to construct the survey. According to another aspect, the survey delivery processing circuit is further adapted to perform pre-processing of at least one question of the survey and/or at least one response to a question of the survey by performing at least one of determining whether a question of the plurality of questions is marked skippable indicating that the question should not be shown to the survey respondent, and/or determining a value by accessing a server and generating one or more additional questions to be provided to the survey respondent if the value is greater than a predefined threshold.

According to one aspect, the survey delivery processing circuit is further adapted to perform post-processing of at least one question of the survey and/or at least one response to a question of the survey by performing at least one of marking a question of the plurality of questions as skippable, and/or receiving a first response to a first question of the plurality of questions, determining that the first response satisfies a condition, and providing a follow-up question to the survey respondent only after determining that the first response satisfies the condition. According to another aspect, the survey apparatus further comprises a response database circuit communicatively coupled to the survey delivery processing circuit, the survey displayed to the survey respondent being a first survey having a first question, and the survey delivery processing circuit further adapted to receive, via the survey input device, a respondent identification (ID) number from the survey respondent taking the first survey, receive, via the survey input device, a first response to the first question of the first survey from the survey respondent, store the first response to the first question of the first survey at the response database circuit, transmit a second survey having the first question to the display device for display of the second survey to the survey respondent, receive, via the survey input device, the respondent ID number from the survey respondent taking the second survey, receive, via the survey input device, a second response to the first question of the second survey from the survey respondent, determine that the respondent ID number received from the survey respondent taking the second survey matches the respondent ID number received from the survey respondent taking the first survey, generate one or more follow-up questions associated with the first question after determining that a difference between the second response and the first response is greater than a predefined threshold value, and transmit the one or more follow-up questions to the display device for display of the one or more follow-up questions to the survey respondent. According to yet another aspect, the survey delivery processing circuit is further adapted to determine, prior to transmitting the plurality of questions of the survey to the display device, that one or more questions of the plurality of questions of the survey have previously been responded to by the survey respondent and responses to the one or more questions are stored at a response database circuit, and pre-populate the one or more questions with the responses stored at the response database circuit and transmit the pre-populated one or more questions to the display device for display to the survey respondent.

Another feature provides a method comprising retrieving a survey having a plurality of questions from a survey storage circuit, transmitting the survey to a display device for display of the survey to a survey respondent, receiving a plurality of responses to the plurality of questions from the survey respondent via a survey input device, and performing at least one of pre-processing, real-time processing, and/or post-processing of at least one question of the survey and/or at least one response to a question of the survey.

### BRIEF DESCRIPTION OF THE DRAWINGS

FIG. 1 illustrates a high-level schematic block diagram of a dynamic questionnaire system.

FIG. 2 illustrates a block diagram of the structure of an exemplary survey.

FIG. 3 illustrates a flow diagram of a three-part workflow management.

FIG. 4 illustrates an example of a respondent-centric survey.

FIG. 5 illustrates how a respondent may be associated with multiple different surveys with the same respondent identification (ID) number.

FIG. 6 illustrates two surveys that a respondent with a particular respondent ID number has taken in the past.

FIG. 7 illustrates an example of dynamic display of survey questions to a respondent.

FIG. 8 illustrates an example of a response storage record that may be stored in a response database module.

FIG. 9 illustrates a flow chart of a method for conducting, analyzing, and storing surveys.

FIG. 10 illustrates a survey apparatus used for conducting, analyzing, and storing surveys.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits and/or modules may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The terms “survey” and “questionnaire” are used interchangeably herein and are used to mean an instrument consisting of a series of questions and/or other prompts for the purpose of gathering information from respondents.

### Exemplary Dynamic Questionnaire System

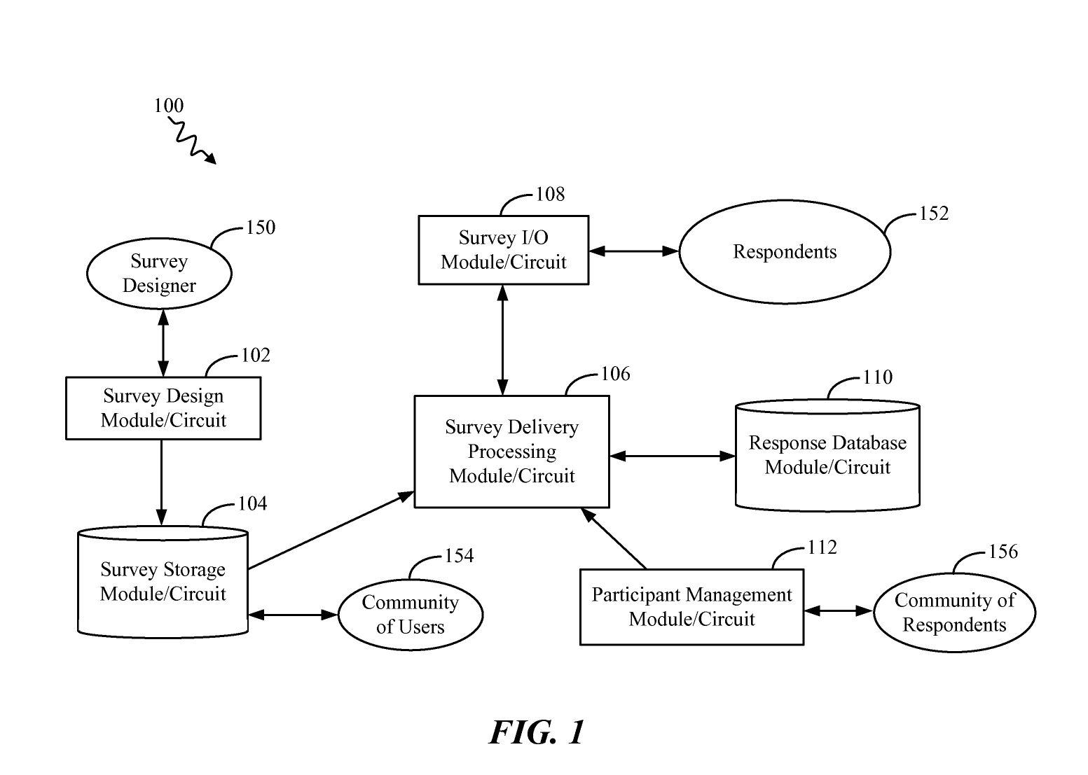

FIG. 1 illustrates a high-level schematic block diagram of a dynamic questionnaire system 100 according to one aspect of the disclosure. The system 100 may include a survey design module/circuit 102, a survey storage module/circuit 104, a survey delivery processing module/circuit 106, a survey input/output (I/O) module/circuit 108, a response database module/circuit 110, and/or a participant management module/circuit 112.

A survey designer 150 may choose to interface with the survey design module 102 to create a survey. The survey designer 150 is typically a person or a group of people but may also be an electronic device. The survey design module 102 may be software and/or hardware that allows the survey designer 150 to construct a survey. The survey may include a plurality of questions, prompts, and/or other actions that, among other things, elicit responses from one or more respondents participating in the survey.

Once the survey is created it may be stored in the survey storage module 104. The survey storage module 104 is a database that stores many different surveys that have been created by one or more survey designers 150. The survey storage module 104 may also store single, stand-alone questions that are independent to surveys. According to some non-limiting examples, the survey storage module 104 may include non-volatile storage devices such as hard drives, optical drives, FLASH memory, cloud-based storage devices, etc. and also volatile storage devices such as volatile memory (e.g., SRAM, DRAM, etc.).

The survey storage module 104 may be accessed by a community of users 154 (may also be referred to as “surveyors,” those that conduct surveys) that can view and/or use the surveys stored at the survey storage module 104. Using a survey in this context means that the user conducts the survey and causes the survey to be distributed to one or more survey respondents who answer and fill out the survey. The survey storage module 104 controls which specific surveys are accessible to which specific community of users 154, and also controls the type of access allowed. As just one example, the storage module 104 may associate a first group of users of the community 154 with a first access rights policy that allows, for example, unlimited access to view and use one or more surveys in the survey storage module 104 as long as those users have contributed their own surveys to the survey storage module 104 under a similar “share-all” restriction-less policy. Similarly, the storage module 104 may associate a second group of users of the community 154 with a second access rights policy that allows them, for example, to view and use select surveys in the survey storage module 104 so long as they pay for the surveys.

Survey fee types may vary considerably and some non-limiting examples include: a pay-per-use basis where the user must pay for each instance they use a survey (e.g., distribute a survey to a survey respondent); or an unlimited survey use structure where the user pays a relatively larger sum up front in order to use a specific survey an unlimited number of times. A third group of users of the community 154 may only be allowed to view select surveys but not use/distribute them. The groups of users described above are merely examples. Any number of restrictions and access types for surveys in the survey storage module 104 may be attributed to different classes of users of the community 154. One or more of the users associated with the community 154 may also be survey designers 150.

The survey delivery processing (SDP) module 106 retrieves, executes, and distributes surveys to the respondents. For example, the SDP module 106 may retrieve a survey from the survey storage module 104, and then execute and distribute the survey to one or more select survey respondents 152 that will take the survey. The SDP 106 may act as the “brain” of the system 100 and perform many pre-processing, real-time processing, and post-processing tasks. The respondents 152 may be one or more persons and in some cases may also be devices. The respondents 152 selected for survey participation may be based on instructions received from the participant management module 112.

The SDP module 106 may transmit questions to and receive responses from the respondent 152 through the survey I/O module 108. The survey I/O module 108 may include various output devices that present the survey (e.g., questions) to the respondent 152. Example of such output devices include, but are not limited to, display devices, renderers, touchscreens, printers, etc. The survey I/O module 108 may also include various input devices that receive responses from the respondent such as, but not limited to, keyboards, mice, cameras, video cameras, touchscreens, etc. Some non-limiting examples of survey I/O modules 108 include desktop computers, laptop computers, tablets, smartphones, mobile phones, personal digital assistants (PDAs), smartwatches, etc.

The response database module 110 stores responses to questions or actions received from the respondent 152. For example, the responses stored may include answers to multiple choice questions generated by the respondent 152 and answers to open-ended questions. The responses stored may be analyzed by the survey designer 150 and/or the community of users 154. Reports and other analytics may be generated based on the responses stored.

Notably, the response database module 110 may also store the full context of the question related to the response. For example, the response database module 110 may store the question posed to the respondent, any help text associated with the question, the question's type, category, language, and also the response to the question. In this fashion when a response from the database module 110 is retrieved, the context of the answer given may also be retrieved to help make full sense of the response stored.

According to one example, the response database module 110 receives the responses from the SDP module 106 and in some aspects the response database module 110 may receive the responses directly from the respondent (e.g., through the survey I/O module 108). The response database module 110 may include non-volatile storage devices such as hard drives, optical drives, FLASH memory, cloud-based storage devices, etc. and also volatile storage devices such as volatile memory (e.g., SRAM, DRAM, etc.) to store the contextual responses.

The participant management module 112 may be tasked with identifying potential respondents 152 to participate in the surveys. For example, the participant management module 112 may determine (e.g., pre-select) a group of potential respondents to participate in a survey if the potential respondents match the certain criteria that are prerequisites to taking the survey. These prerequisites may include being a specific gender, age, demographic, and/or having a certain domicile. The participant management module 112 may contact the potential respondents and enroll them in the survey.

The participant management module 112 may also be in communication with or include a community of respondents 156 where survey respondents 152 or potential survey respondents can share stories, experiences, and/or questions regarding surveys they have taken or may take. In one aspect the community of respondents 156 may be the same, at least in part, as the community of users 154 who can access surveys stored in the survey storage module 104.

### Exemplary Survey

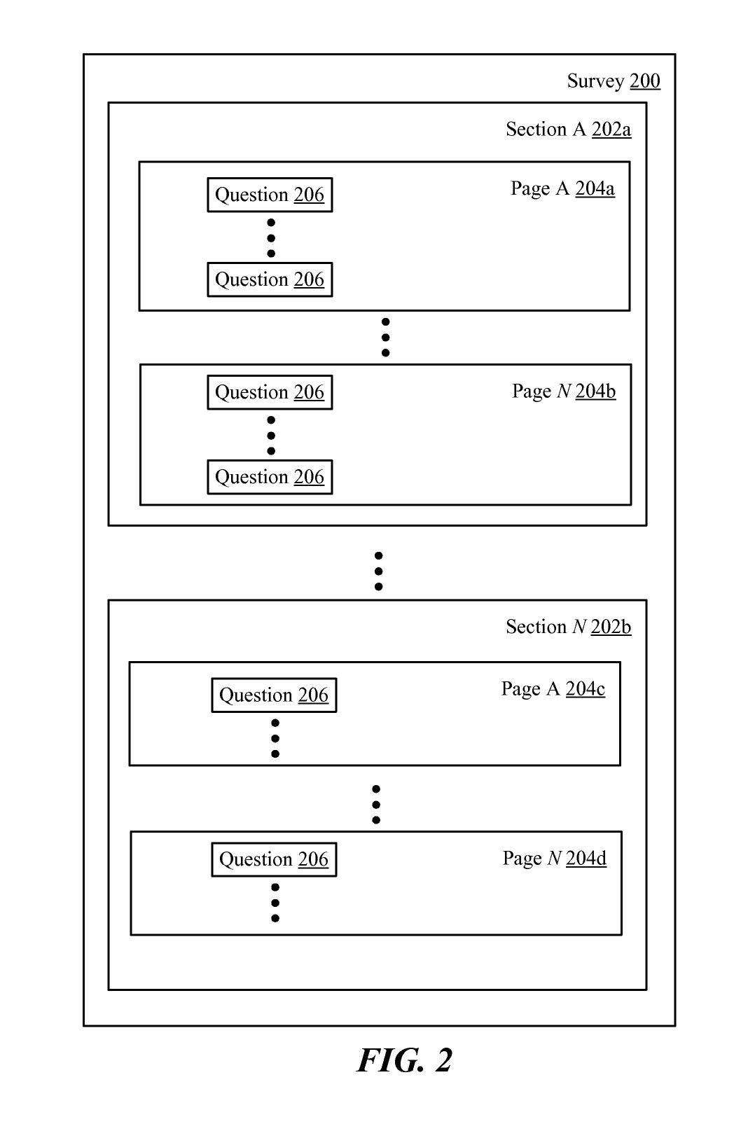

FIG. 2 illustrates a block diagram of the structure of an exemplary survey 200. The survey 200 may include one or more sections 202a, 202b, which may each include one or more pages 204a-204d that may in turn each include one or more questions 206. According to one aspect, each page 204a-204d, including some or all of its questions 206, may be displayed in their entirety to a respondent 152. The survey I/O module 108 may be used to display the pages of questions to the respondent 152.

For example, a respondent 152 taking the survey 200 may be first presented with Section A's 202a first page 204a. After the respondent 152 responds or is otherwise done with the one or more questions associated with the first page 204a, the SDP module 106 receives the respondent's 152 responses and executes the next page 204b to be displayed to the respondent 152. The SDP module 106 loads each page 204a-204d of the survey 200 to the respondent 152 until all of the pages 204a-204d of all the sections 202a, 202b have been displayed and/or otherwise the SDP module 106 terminates the survey 200.

### Exemplary Workflow Management

Workflow management of a survey is achieved by allowing the survey designer to define executable actions at three points: before presenting a question(s) to a respondent (referred to as “pre-processing”); while the question(s) is presented to the respondent (referred to as “real-time processing”); and after the respondent has answered the question(s) (referred to as “post-processing”). According to one aspect, the SDP module 106 performs the pre-processing, real-time processing, and post-processing actions.

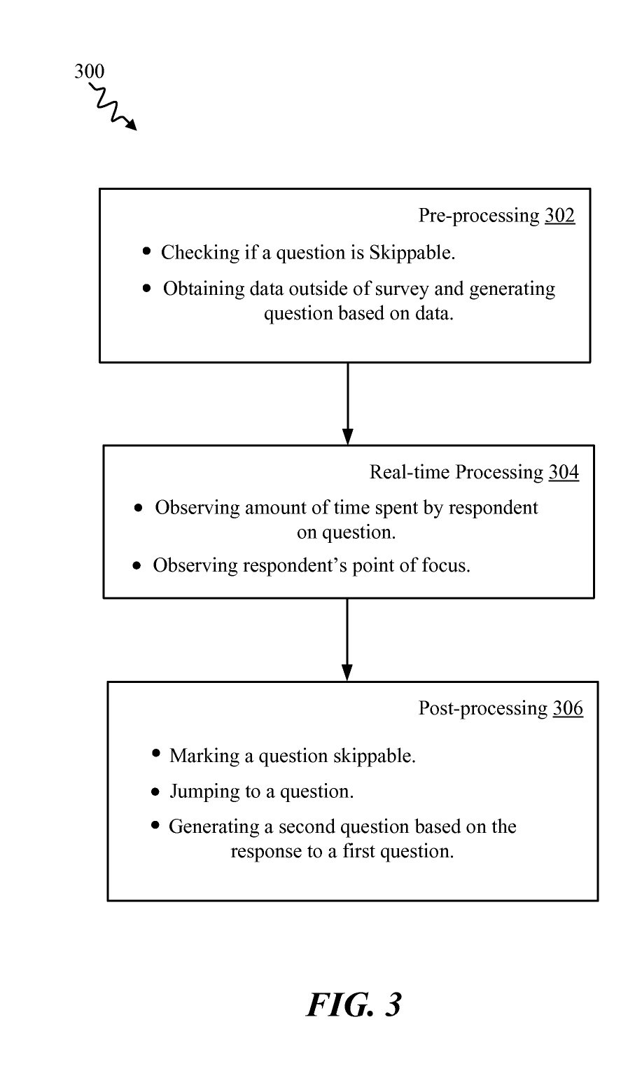

FIG. 3 illustrates a flow diagram of a three-part workflow management 300 according to one aspect of the disclosure.

One non-limiting example of pre-processing 302 includes checking to see whether a question that would otherwise be presented to a respondent is marked as “skippable” (i.e., the question is to be skipped on this occasion or for this particular respondent) and is thus not presented to the respondent. Another non-limiting example of pre-processing includes determining some value or executing a conditional statement and then presenting a question to the respondent based on the outcome of the value or conditional statement. For instance, the SDP module 106 executing pre-processing of a survey question related to a respondent's health may first check the weather (e.g., by accessing a server having local weather information over a computer network) and depending on the weather conditions reported (e.g., humidity above a certain threshold, barometric pressure below a certain threshold, etc.) ask the respondent specific questions such as whether the respondent is experiencing arthritic pain.

One non-limiting example of real-time processing 304 includes observing and storing the amount of time a respondent takes to respond to a question. Another example includes observing where the respondent is focusing his attention while answering a question. That is, the system may determine where on the display screen showing the question the user is focusing their vision on while answering the question.

One non-limiting example of post-processing 306 includes analyzing a response given by a respondent to a first question and generating/distributing a second question (e.g., follow-up question) to the respondent based on their response to the first question. Another example includes marking a question as skippable and/or jumping to another question (i.e., a question out of sequence) based on the response to a first question.

Some of the actions described above may occur in any of the three points (i.e., during pre-processing, real-time processing, or post-processing). Other examples that may occur at any of the three points include performing calculations, looping over a question or set of questions, executing external programs, and executing conditional actions (e.g., “if-then-else” statements, case, switch, and branch statements, and pattern matching).

### Respondent-Centric Survey Systems

Traditional surveys are “survey-centric” because the analysis of questions is done as a calculation of the responses for all the respondents (or groups of respondents) to a specific survey. By contrast, the surveys and survey systems described herein, such as the survey system 100 and survey 200 shown in FIGS. 1 and 2, may be considered “respondent-centric” in that the analysis of the responses is done for individual respondents. For example, if an analysis of a survey is performed over time (e.g., the survey is given to the same respondent week after week for a period of time), the focus of the analysis can be on the variation of the answers to the same questions in the survey for each individual respondent.

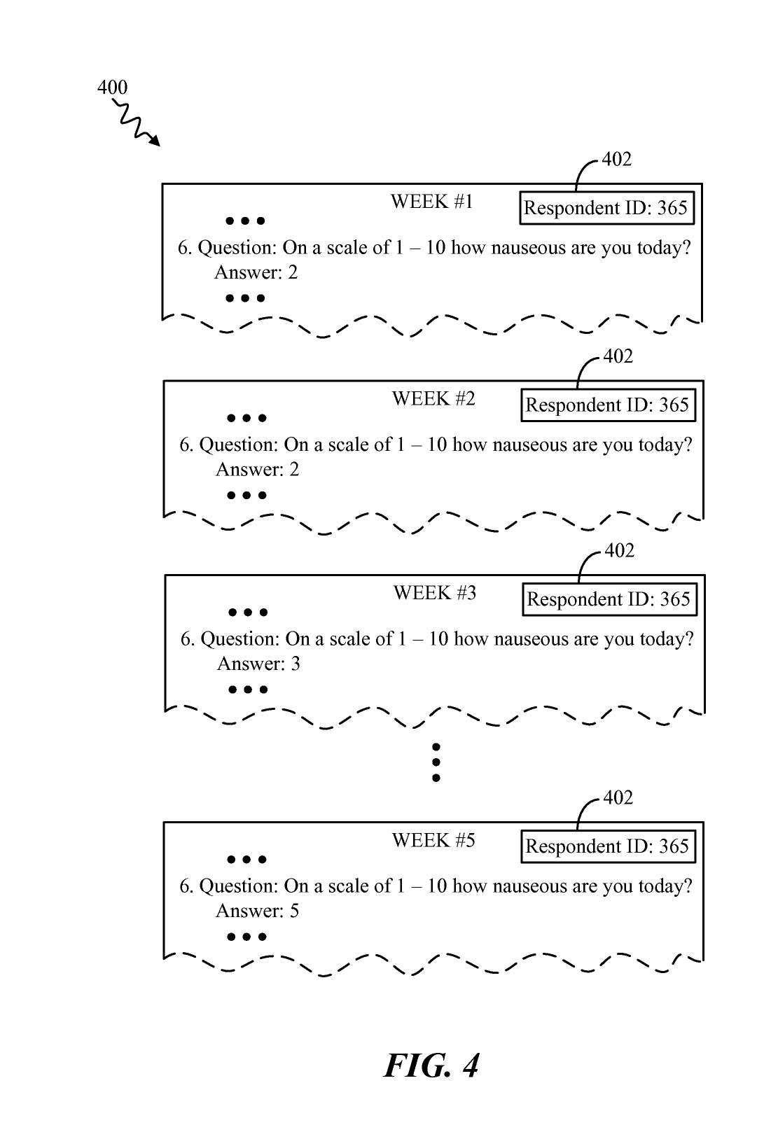

FIG. 4 illustrates an example of a respondent-centric survey 400 according to one aspect. The survey 400 is given to a respondent who is identified by a unique respondent ID number 402. That is, each respondent uses the same unique ID number 402 assigned to them for all of the surveys that they take. In this case the survey 400 is given to a respondent every week for a length of time such as sixteen (16) weeks. The survey 400 includes a question (e.g., question number 6) that asks, for example, “On a scale of 1-10 how nauseous are you today?” Referring to FIGS. 1 and 4, the SDP module 106 may analyze the responses given to this question for this particular respondent and determine whether there is a significant change from one week to another week. For example, if the respondent answered “2” or “3” for weeks 1-4 but then on week 5 the respondent answered a “5” the SDP module 106 may determine that the jump from “2” or “3” to “5” is a significant change and the SDP module 106 may take certain actions such as prompting the respondent with additional questions related to nausea that it otherwise would not ask had the respondent's nausea not significantly changed in time.

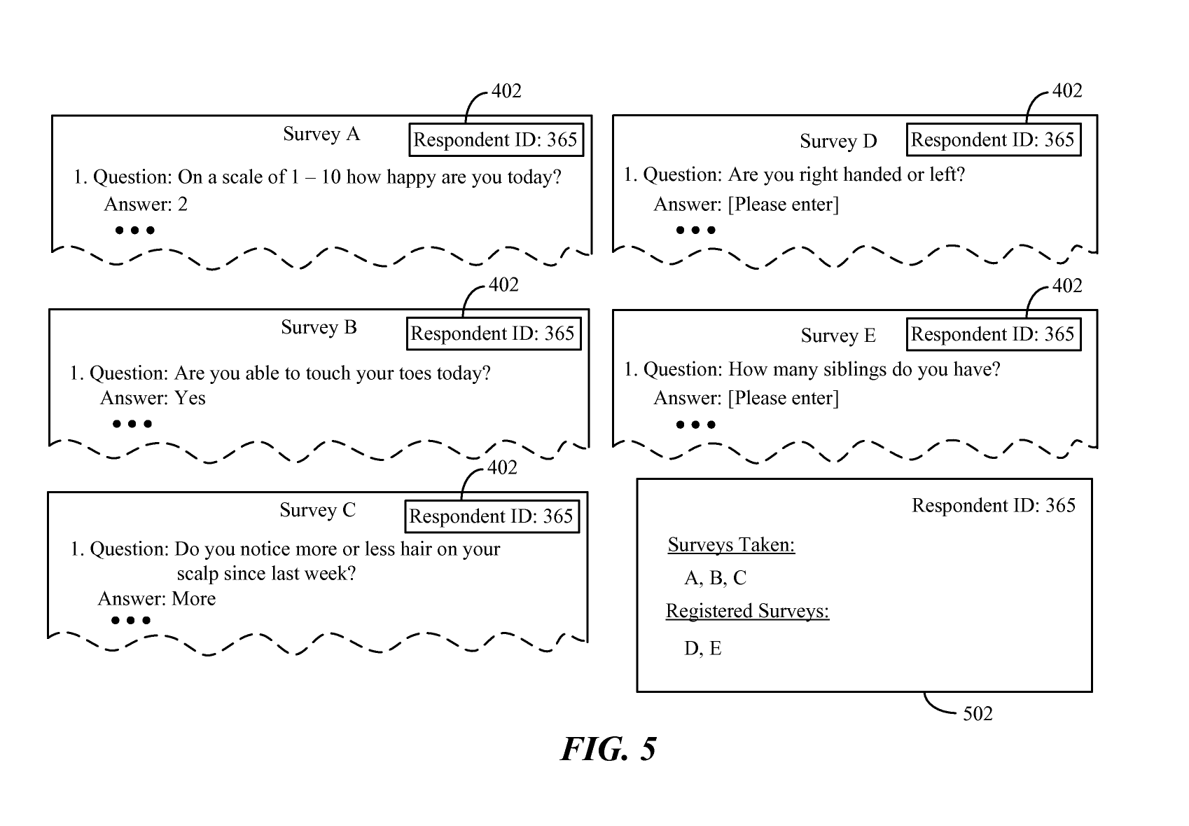

FIG. 5 illustrates how a respondent may be associated with multiple different surveys with the same respondent ID number. The respondent having an ID number 365 may have taken surveys A, B, and C, and may be registered to take (in the near future) surveys D and E. A table 502 may be generated upon request after entering in a respondent's ID number. The table 502 lists all the surveys thus far taken by the respondent ID entered including the surveys the respondent is registered to take. Such a system helps facilitate a respondent-centric survey system.

### Pre-Population

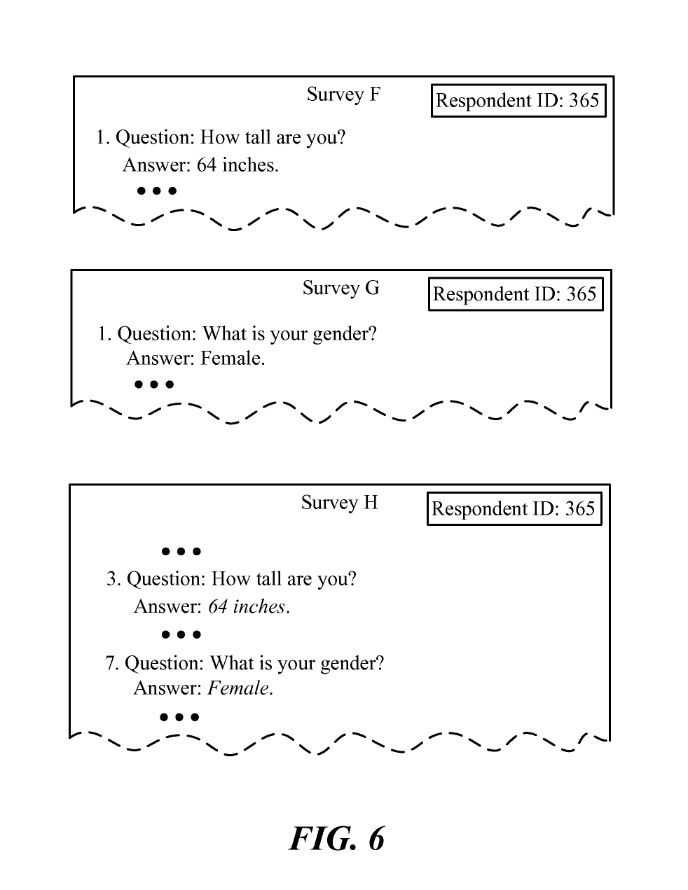

A respondent-centric survey system allows pre-population of answers for a survey the respondent has never taken based on answers to same or similar questions the respondent has already given. For example, FIG. 6 illustrates Surveys F and G that respondent ID 365 has taken in the past. Survey F asked the respondent how tall she is and Survey G asked the respondent what gender she is. For future surveys the respondent takes we do not expect her answers to these questions to change and therefore the subsequent survey that they take (e.g., Survey H) can already have the answers to these questions pre-populated (i.e., filled out). The respondent may change the pre-populated answers in the rare event the answers to these questions have changed.

In one aspect, some of these questions with pre-populated answers may be hidden from the respondent to simplify the survey and lessen the number of questions/answers the respondent must review when participating in the survey. The survey designer can choose to present the pre-populated answer (and the question) depending on whether: the question is part of the same survey currently being answered; the question is part of any other survey that contains the same question; the amount of time the question was previously answered in exceeds a threshold value; and/or a result of a workflow management action determines it should or shouldn't be displayed.

According to one aspect, referring to FIGS. 1 and 6, the SDP module 106 may be tasked with accessing the response database storage module 110 to retrieve the answers from Surveys F and G in order to pre-populate Survey H (pre-populated answers are shown in italics in FIG. 6). Each question in each survey may have an identification number associated with it too where identical questions (e.g., what is your gender) are assigned the same identification number to assist SDP module 106 in identifying which questions across various surveys are the same.

### Dynamic Display of Questions

According to one aspect of the disclosure, survey questions may be presented to the respondent only if the workflow defined by a survey designer so specifies. For example, not all the questions of a survey may necessarily be presented to a respondent. In some cases, a question may be displayed dynamically only after a specific response necessitating the question is received from the respondent.

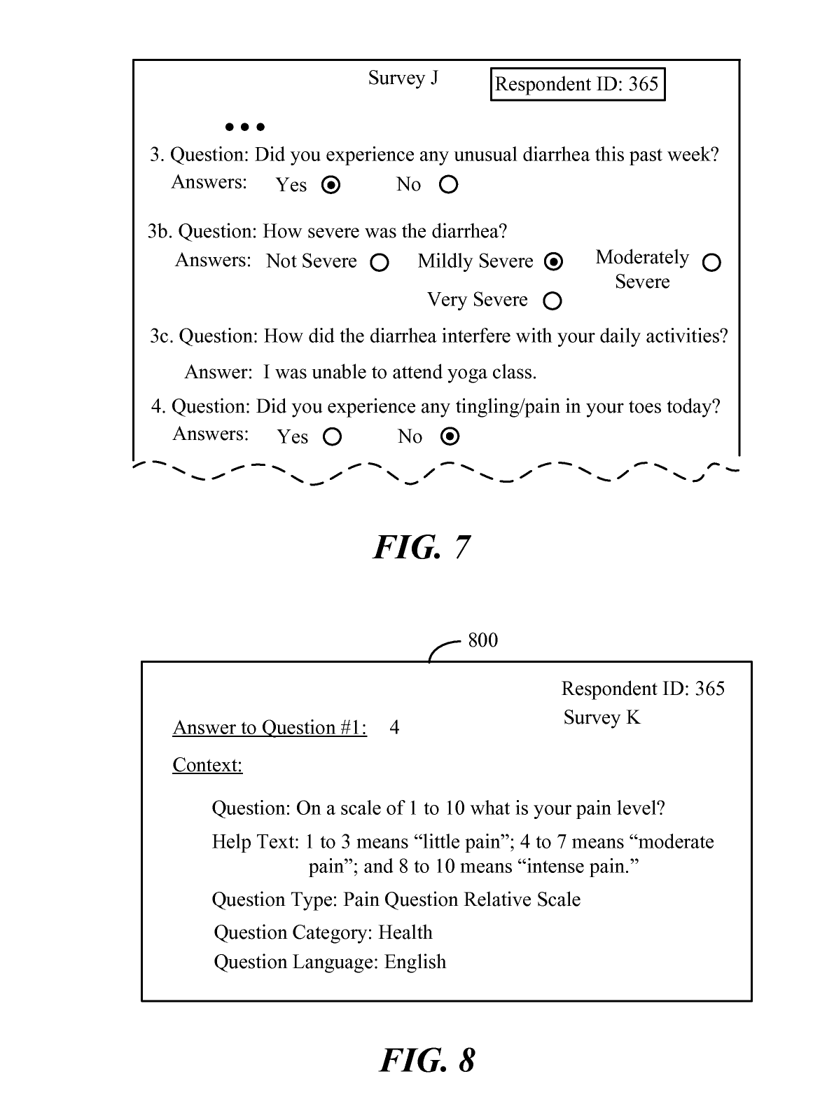

FIG. 7 illustrates one non-limiting example of dynamic display of survey questions to a respondent. Survey J may first cause a display device to prompt (e.g., display) the respondent with a question that asks “Did you experience any unusual diarrhea this past week?” along with a multiple choice answer selection of “Yes” and “No.” Only if the respondent answers “Yes” may the survey further cause the display device to prompt the respondent with another related question “How severe was the diarrhea?” along with answers choices “Not Severe,” “Mildly Severe,” “Moderately Severe,” and “Very Severe.” Similarly, only if the respondent responds with “Mildly Severe,” “Moderately Severe,” or “Very Severe” will the survey cause the display device to prompt the respondent with the next related question that asks “How did the diarrhea interfere with your daily activities?” If the answer choice to Question 3 was “No,” then Questions 3b and 3c are never shown or prompted to the respondent and the survey would continue on with Question 4. In this fashion the survey dynamically displays questions to the respondent based on responses received from the respondent.

### Contextual Storage of Answers

As described in part above, the response database module 110 is not limited in storing just the response to a survey question but instead may also store the full context of the question related to the response. FIG. 8 illustrates one non-limiting example of a response storage record 800 that may be stored in the response database module 110. The response given to the specific question asked to the respondent during the survey in this case is “4.” However, not knowing anything about the context in which this response was provided a person reviewing this answer would not be able to make full sense of it. Advantageously, the record 800 also includes the question asked to the respondent. Now someone reviewing this answer would know that an answer of “4” is likely not an indicator of severe pain since the scale presented to the respondent was from “1 to 10” and not, for example, from “1 to 5.” In the example illustrated, the record 800 also indicates the help text provided to the respondent, the question's type, category, and language of the question. These features do not necessarily have to be stored along with the answer/response but are merely examples of additional information that may be stored to provide context to the answer stored.

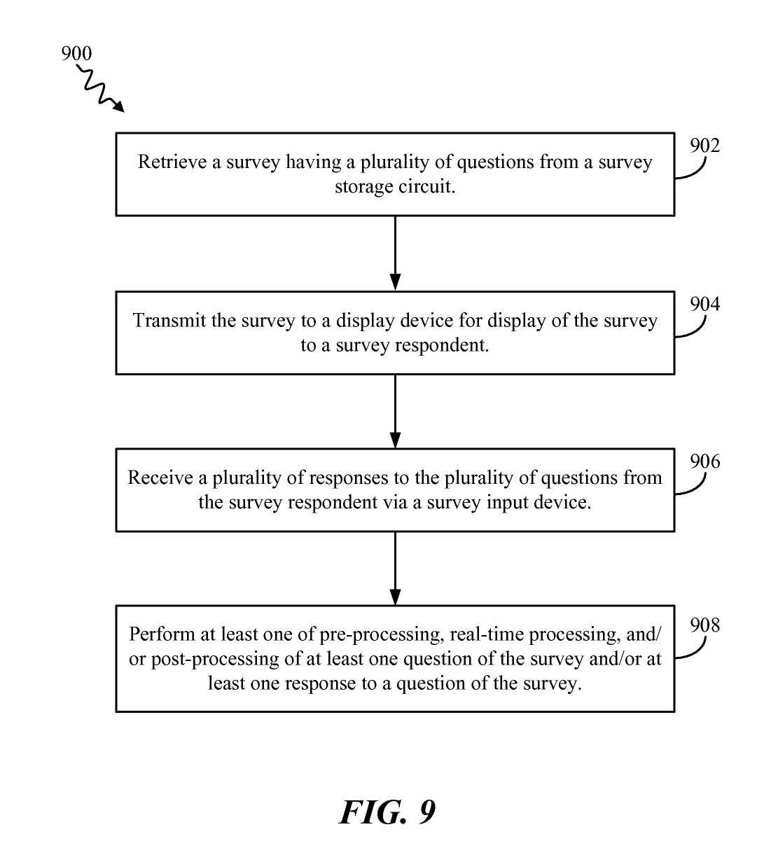

FIG. 9 illustrates a flow chart of a method 900 according to one aspect of the disclosure. First, a survey having a plurality of questions is retrieved from a survey storage circuit. Next, the survey is transmitted to a display device for display of the survey to a survey respondent. Then, a plurality of responses to the plurality of questions are received from the survey respondent via a survey input device. Next, at least one of pre-processing, real-time processing, and/or post-processing is performed of at least one question of the survey and/or at least one response to a question of the survey.

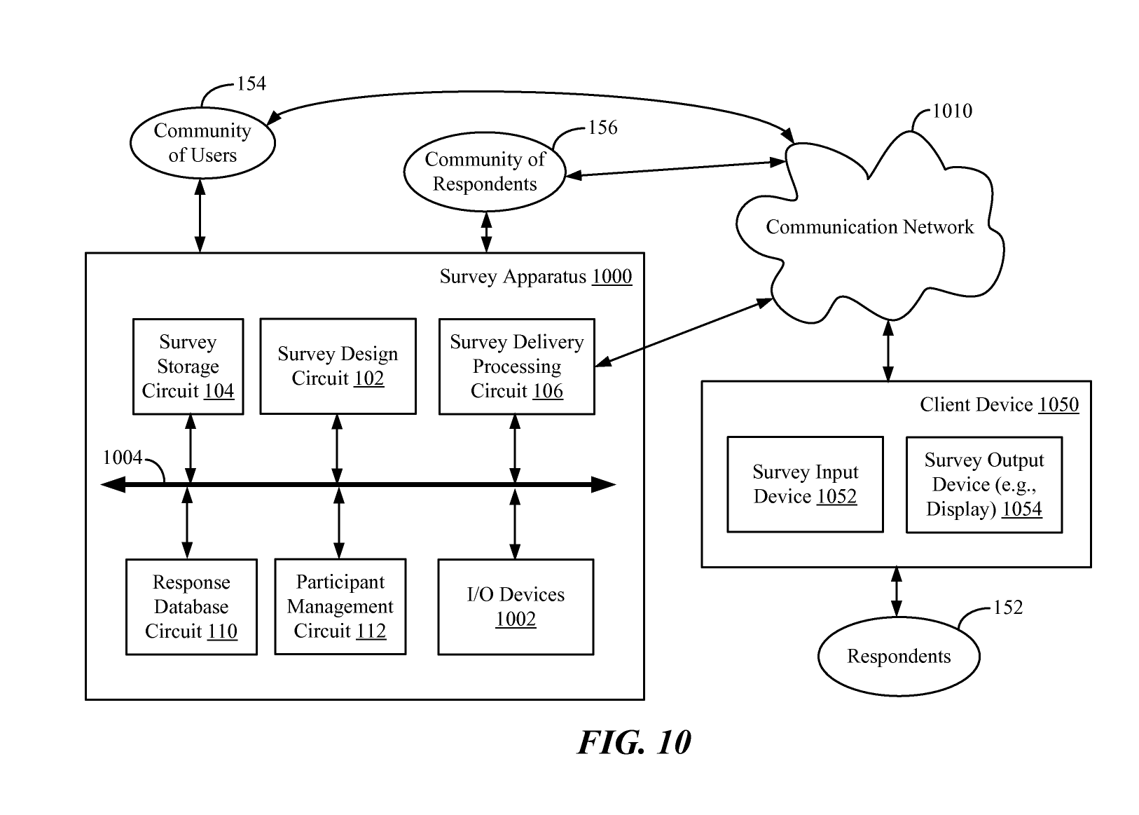

FIG. 10 illustrates a survey apparatus 1000 used for conducting, analyzing, and storing surveys according to one aspect of the disclosure. The survey apparatus 1000 may include the survey design circuit 102, the survey storage circuit 104, the survey delivery processing circuit 106, the response database circuit 110, the participant management circuit 112, and/or one or more input/output (I/O) devices 1002 that may all be communicatively coupled to one another through a communication bus 1004. The survey apparatus 1000 may be in communication (either directly or through one or more communication networks 1010) with a community of users 154 that may design and conduct surveys, and may also be in communication (either directly or through one or more communication networks 1010) with a community of respondents 156 that may share stories, experiences, and questions about surveys they've taken or will take in the future.

The I/O devices 1002 may include displays, printers, keyboards, computer mice, touchscreen displays, speakers, etc. The survey design circuit 102 allows one or more users 154 (e.g., survey designers 150 in FIG. 1) to construct and design surveys. The survey storage circuit 104 may store one or more surveys each having a plurality of questions. The response database circuit 110 may store a plurality of responses received to the plurality of questions of a survey. The database circuit 110 may further store the plurality of questions too for which responses were received in order to associated the responses to the questions and provide context to the responses. The response database circuit 110 may also store a question type, a question category, and a question language associated with each question of the plurality of questions. The participant management circuit 112 may identify potential respondents that match one or more prerequisites to take the survey, the one or more prerequisites including at least one of being a specific gender, being within a specific age range, being a specific demographic profile, and/or having a specific domicile. The participant management circuit 112 may also receive, store, and share experiences associated with the survey written by a community of respondents 156.

The client device 1050 may be any communication device, such as a laptop, desktop computer, tablet, smartphone, smartwatch, personal digital assistant (PDA), server, etc. that allows one or more survey respondents to communicate with the survey apparatus 1000 and take surveys. Among other things, the client device 1050 may include one or more survey input devices 1052 and one or more survey output devices 1054. Some non-limiting, non-exclusive examples of survey input devices 1052 include touchscreen displays, computer mice, keyboards, joysticks, cameras, etc. Some non-limiting, non-exclusive examples of survey output devices 1054 include display devices, printers, etc.

The survey delivery processing circuit 106 may: retrieve a survey from the survey storage circuit 104; transmit a survey to a display device 1054 for display of a survey to a survey respondent 152; receive a plurality of responses to the plurality of questions from a survey respondent 152 via a survey input device 1052; perform at least one of pre-processing, real-time processing, and/or post-processing of at least one question of the survey and/or at least one response to a question of the survey; determine whether a question of the plurality of questions is marked skippable indicating that the question should not be shown to a survey respondent 152; determine a value by accessing a server (e.g., external third party server) and generating one or more additional questions to be provided to a survey respondent 152 if the value is greater than a predefined threshold; mark a question of a plurality of questions as skippable; receive a first response to a first question of a plurality of questions, determine that the first response satisfies a condition, and provide a follow-up question to a survey respondent 152 only after determining that the first response satisfies the condition; receive, via a survey input device 1052, a respondent ID number from a survey respondent 152 taking a first survey.

The survey delivery processing circuit 106 may also: receive, via a survey input device 152, a first response to a first question of a first survey from a survey respondent 152; store a first response to a first question of a first survey at a response database circuit 110; transmit a second survey having a first question to a display device 1054 for display of the second survey to a survey respondent 152; receive, via a survey input device 1052, a respondent ID number from a survey respondent 152 taking a second survey; receive, via a survey input device 152, a second response to a first question of a second survey from a survey respondent 152; determine that a respondent ID number received from a survey respondent 152 taking a second survey matches the respondent ID number received from the survey respondent 152 taking a first survey; generate one or more follow-up questions associated with a first question after determining that a difference between a second response and a first response is greater than a predefined threshold value; transmit one or more follow-up questions to a display device 1054 for display of the one or more follow-up questions to a survey respondent 152; determine, prior to transmitting a plurality of questions of a survey to a display device 1054, that one or more questions of the plurality of questions of the survey have previously been responded to by a survey respondent 152 and responses to the one or more questions are stored at a response database circuit 110; pre-populate one or more questions with responses stored at a response database circuit 110 and transmit the pre-populated one or more questions to a display device 1054 for display to a survey respondent 152; store and manage a plurality of access rights policies associated with a plurality of users 154, the access rights policies defining which of a plurality of surveys the plurality of users 154 may access and what type of access each user of the plurality of users are allowed; transmit to a display device 1054 one page of a survey at a time; determine an amount of time a survey respondent 152 takes to answer a question of a plurality of questions; determine a location on a display device 1054 that a survey respondent 152 is focusing their attention on while being shown a question of a plurality of questions; assign a unique respondent ID number to each survey respondent 152 taking a survey, the same respondent ID number being reused by each survey respondent 152 for all subsequent surveys distributed to the survey respondents 152.

One or more of the components, steps, features, and/or functions illustrated in FIGS. 1, 2, 3, 4, 5, 6, 7, 8, 9, and/or 10 may be rearranged and/or combined into a single component, step, feature or function or embodied in several components, steps, or functions. Additional elements, components, steps, and/or functions may also be added without departing from the invention. The apparatus, devices, and/or components illustrated in FIGS. 1 and 10 may be configured to perform one or more of the methods, features, or steps described in FIGS. 2, 3, 4, 5, 6, 7, 8, and/or 9. The algorithms described herein may also be efficiently implemented in software and/or embedded in hardware.

Moreover, in one aspect of the disclosure, the SDP circuit 106 illustrated in FIGS. 1 and 10 may be a specialized processor (e.g., an application specific integrated circuit (e.g., ASIC)) that is specifically designed and/or hard-wired to perform the algorithms, methods, and/or steps described in FIGS. 2, 3, 4, 5, 6, 7, 8, and/or 9. Thus, such a specialized processor (e.g., ASIC) may be one example of a means for executing the algorithms, methods, and/or steps described in FIGS. 2, 3, 4, 5, 6, 7, 8, and/or 9.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing or containing instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, aspects of the disclosure may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A non-transitory computer-readable medium comprising instructions stored thereon, which when executed by at least one processor, perform the steps of:
retrieve a survey having a plurality of questions from a survey storage circuit;
transmit the survey to a display device for display of the survey to a survey respondent;
receive a plurality of responses to the plurality of questions from the survey respondent via a survey input device; and
perform at least one of pre-processing, real-time processing, and/or post-processing of at least one question of the survey and/or at least one response to a question of the survey.

2. The non-transitory computer-readable medium of claim 1, wherein the survey storage circuit is adapted to store a plurality of surveys, and the instructions when executed by the processor, further perform the steps of:
store and manage a plurality of access rights policies associated with a plurality of users, the access rights policies defining which of the plurality of surveys the plurality of users may access and what type of access each user of the plurality of users are allowed.

3. The non-transitory computer-readable medium of claim 2, wherein a first group of users of the plurality of users is associated with a first access rights policy allowing them to access one or more of the plurality of surveys without fee, and a second group of users of the plurality of users is associated with a second access rights policy allowing them to access one or more of the plurality of surveys for a fee.

4. The non-transitory computer-readable medium of claim 1, wherein the instructions when executed by the processor, further perform the steps of:
store the plurality of responses at a response database circuit; and
store the plurality of questions for which the plurality of responses were received at the response database circuit; and
associate each of the plurality of the questions with each of the plurality of responses in order to provide context to the responses stored.

5. The non-transitory computer-readable medium of claim 4, wherein the instructions when executed by the processor, further perform the step of:
store a question type, a question category, and a question language associated with each question of the plurality of questions.

6. The non-transitory computer-readable medium of claim 1, wherein the instructions when executed by the processor, further perform the step of:
identify potential survey respondents that match one or more prerequisites to take the survey, the one or more prerequisites including at least one of being a specific gender, being within a specific age range, being a specific demographic profile, and/or having a specific domicile.

7. The non-transitory computer-readable medium of claim 6, wherein the instructions when executed by the processor, further perform the steps of: receive, store, and share experiences associated with the survey written by a community of respondents.

8. The non-transitory computer-readable medium of claim 1, wherein the survey includes one or more sections, the one or more sections each including one or more pages, and the one or more pages each including one or more questions of the plurality of questions, and the instructions when executed by the processor, further perform the step of:
transmit to the display device one page of the survey at a time.

9. The non-transitory computer-readable medium of claim 1, wherein the instructions when executed by the processor, further perform the step of:
perform pre-processing of at least one question of the survey and/or at least one response to a question of the survey by
determining whether a question of the plurality of questions is marked skippable indicating that the question should not be shown to the survey respondent, and/or
determining a value by accessing a server and generating one or more additional questions to be provided to the survey respondent if the value is greater than a predefined threshold.

10. The non-transitory computer-readable medium of claim 1, wherein the instructions when executed by the processor, further perform the step of:
perform real-time processing of at least one question of the survey and/or at least one response to a question of the survey by
determining an amount of time the survey respondent takes to answer a question of the plurality of questions, and/or
determining a location on the display device that the survey respondent is focusing their attention on while being shown a question of the plurality of questions.

11. The non-transitory computer-readable medium of claim 1, wherein the instructions when executed by the processor, further perform the step of:
perform post-processing of at least one question of the survey and/or at least one response to a question of the survey by
marking a question of the plurality of questions as skippable, and/or
receiving a first response to a first question of the plurality of questions, determining that the first response satisfies a condition, and providing a follow-up question to the survey respondent only after determining that the first response satisfies the condition.

12. The non-transitory computer-readable medium of claim 1, wherein the instructions when executed by the processor, further perform the step of:
assign a unique respondent identification (ID) number to each survey respondent taking the at least one survey, the same respondent ID number being reused by each survey respondent for all subsequent surveys distributed to the survey respondents.

13. The non-transitory computer-readable medium of claim 1, wherein the survey displayed to the survey respondent is a first survey having a first question, wherein the instructions when executed by the processor, further perform the steps of:
receive, via the survey input device, a respondent identification (ID) number from the survey respondent taking the first survey;
receive, via the survey input device, a first response to the first question of the first survey from the survey respondent;
store the first response to the first question of the first survey at a response database circuit;
transmit a second survey having the first question to the display device for display of the second survey to the survey respondent;
receive, via the survey input device, the respondent ID number from the survey respondent taking the second survey;
receive, via the survey input device, a second response to the first question of the second survey from the survey respondent;
determine that the respondent ID number received from the survey respondent taking the second survey matches the respondent ID number received from the survey respondent taking the first survey;
generate one or more follow-up questions associated with the first question after determining that a difference between the second response and the first response is greater than a predefined threshold value; and
transmit the one or more follow-up questions to the display device for display of the one or more follow-up questions to the survey respondent.

14. The non-transitory computer-readable medium of claim 1, wherein the instructions when executed by the processor, further perform the steps of:
determine, prior to transmitting the plurality of questions of the survey to the display device, that one or more questions of the plurality of questions of the survey have previously been responded to by the survey respondent and responses to the one or more questions are stored at a response database circuit; and
pre-populate the one or more questions with the responses stored at the response database circuit and transmit the pre-populated one or more questions to the display device for display to the survey respondent.

15. A survey apparatus comprising:
a survey storage circuit adapted to store at least one survey having a plurality of questions; and
a survey delivery processing circuit communicatively coupled to the survey storage circuit, the survey delivery processing circuit adapted to:
retrieve the survey from the survey storage circuit;
transmit the survey to a display device for display of the survey to the survey respondent;
receive a plurality of responses to the plurality of questions from the survey respondent via a survey input device; and
perform at least one of pre-processing, real-time processing, and/or post-processing of at least one question of the survey and/or at least one response to a question of the survey.

16. The survey apparatus of claim 15, further comprising:
a survey design circuit adapted to allow a user to construct the survey.

17. The survey apparatus of claim 15, wherein the survey delivery processing circuit is further adapted to perform pre-processing of at least one question of the survey and/or at least one response to a question of the survey by performing at least one of:
determining whether a question of the plurality of questions is marked skippable indicating that the question should not be shown to the survey respondent; and/or
determining a value by accessing a server and generating one or more additional questions to be provided to the survey respondent if the value is greater than a predefined threshold.

18. The survey apparatus of claim 15, wherein the survey delivery processing circuit is further adapted to perform post-processing of at least one question of the survey and/or at least one response to a question of the survey by performing at least one of:
marking a question of the plurality of questions as skippable; and/or
receiving a first response to a first question of the plurality of questions, determining that the first response satisfies a condition, and providing a follow-up question to the survey respondent only after determining that the first response satisfies the condition.

19. The survey apparatus of claim 1, further comprising a response database circuit communicatively coupled to the survey delivery processing circuit, the survey displayed to the survey respondent being a first survey having a first question, and the survey delivery processing circuit further adapted to:
receive, via the survey input device, a respondent identification (ID) number from the survey respondent taking the first survey;
receive, via the survey input device, a first response to the first question of the first survey from the survey respondent;
store the first response to the first question of the first survey at the response database circuit;
transmit a second survey having the first question to the display device for display of the second survey to the survey respondent;
receive, via the survey input device, the respondent ID number from the survey respondent taking the second survey;
receive, via the survey input device, a second response to the first question of the second survey from the survey respondent;
determine that the respondent ID number received from the survey respondent taking the second survey matches the respondent ID number received from the survey respondent taking the first survey;
generate one or more follow-up questions associated with the first question after determining that a difference between the second response and the first response is greater than a predefined threshold value; and
transmit the one or more follow-up questions to the display device for display of the one or more follow-up questions to the survey respondent.

20. The survey apparatus of claim 15, wherein the survey delivery processing circuit is further adapted to:
determine, prior to transmitting the plurality of questions of the survey to the display device, that one or more questions of the plurality of questions of the survey have previously been responded to by the survey respondent and responses to the one or more questions are stored at a response database circuit; and
pre-populate the one or more questions with the responses stored at the response database circuit and transmit the pre-populated one or more questions to the display device for display to the survey respondent.

21. A method comprising:
retrieving a survey having a plurality of questions from a survey storage circuit;
transmitting the survey to a display device for display of the survey to a survey respondent;
receiving a plurality of responses to the plurality of questions from the survey respondent via a survey input device; and
performing at least one of pre-processing, real-time processing, and/or post-processing of at least one question of the survey and/or at least one response to a question of the survey.
